(19) United States
(12) Patent Application Publication
(10) Pub. No.: US 2014/0137714 A1
(43) Pub. Date: May 22, 2014

(54) SENSING AND CONTROL TECHNIQUES FOR AUTOMATED HAIR CUTTING SYSTEM

(71) Applicant: Matthew W. Krenik, Garland, TX (US)

(72) Inventor: Matthew W. Krenik, Garland, TX (US)

(21) Appl. No.: 14/086,497

(22) Filed: Nov. 21, 2013

Related U.S. Application Data
(60) Provisional application No. 61/728,851, filed on Nov. 21, 2012.
(60) Provisional application No. 61/780,086, filed on Mar. 13, 2013.

(51) Int. Cl. B26B 19/00

(52) U.S. Cl. CPC B26B 19/00
USPC 83/23; 83/74; 83/13

(57) ABSTRACT

Disclosed herein are various embodiments of an automated hair cutting system. The system comprises a hair cutting device; at least one sensor, said sensor providing signals utilized by said automated hair cutting system to compute a position of said hair cutting device relative to a user's head and face; and a control system for actuating a cutter head attached to said hair cutting device, said cutter head configured for collecting hair therein during operation of said hair cutting device and thereafter cutting the collected hair according to the user's selected hair length and hair style. The control system may execute a safety sequence for initiating the hair cutting device comprising multiple pre-defined safety verifications before beginning operation of the hair cutting device.

### CROSS REFERENCE TO RELATED APPLICATION

This application claims the benefit of U.S. Provisional Application Ser. No. 61/728,851, filed by Matthew W. Krenik on Nov. 21, 2012 and entitled “Cutter Head Sensing and Control for Automated Hair Cutting System”; and U.S. Provisional Application Ser. No. 61/780,086, filed by Matthew W. Krenik on Mar. 13, 2013 and entitled “Techniques for Automated Hair-Cutting System,” both commonly owned with this application and incorporated herein by reference.

### FIELD OF THE DISCLOSURE

The present disclosure relates generally to hair cutting systems and methods, and more particularly to a sensing and control apparatus and methods for use with an automated hair cutting system.

### BACKGROUND

International application number PCT/US12/70856, filed by Matthew W. Krenik on Dec. 20, 2012, entitled “Automated Hair Cutting System and Method of Operation Thereof” (hereinafter “Krenik '856”), provides a description of automated hair cutting systems. These systems operate by determining the position and/or orientation of a hair cutting device relative to a user receiving a haircut. Hair may be collected in a cutter head and extended for cutting to a beneficial length. Through electronic measurements and computational analysis, the location of where hair on the scalp of a user is collected into a cutter head may be determined and as hair is extended and slides through a cutter head, its length may be substantially determined so that a cutter head may be actuated at a beneficial time to cut hair to a beneficial length. Successful operation of an automated hair cutting system depends on successful intercommunication between the system elements and on successfully determining when a cutter head may be actuated for cutting. Accordingly, techniques that improve system reliability, enable fail-safe operation, improve sensing of system elements, and provide criteria for when a cutter head may be actuated are highly desirable.

### SUMMARY

Disclosed herein are various embodiments of automated hair cutting systems and various features for use therewith. In one embodiment, an automated hair cutting system comprises a hair cutting device; at least one sensor, said sensor providing signals utilized by said automated hair cutting system to compute a position of said hair cutting device relative to a user's head and face; and a control system for actuating a cutter head attached to said hair cutting device, said cutter head configured for collecting hair therein during operation of said hair cutting device and thereafter cutting the collected hair according to the user's selected hair length and hair style. The control system may execute a safety sequence for initiating the hair cutting device comprising multiple pre-defined safety verifications before beginning operation of the hair cutting device

In another embodiment, a control apparatus for use with automated hair cutting systems comprises at least one sensor configured to determine a position of a cutting device relative to a user's head; a communication link for communicating with the cutting device; and a computing device for processing information from the at least one sensor and preparing instructions for the cutting device.

In yet another embodiment, a method is disclosed for initiating a hair cutting system comprising a cutter head, control device, and a plurality of sensors. The method comprises verifying positioning of the cutter head relative to the user's head; verifying, based on input from at least one of the plurality of sensors, that the cutter head is positioned at a minimum distance away from the user's eyes; verifying that the cutter head is free of obstructions; verifying that the cutter head is configured to respond to a stop command from the control device; and initiating the hair cutting system.

In some embodiments, control system criteria may be established to help ensure that a cutter head is only actuated when it is substantially safe to do so. Fail-safe intercommunication and synchronization between system elements may allow electronic computing devices, hair cutting devices, positioning devices, and possibly additional system elements to reliably and safely exchange system and control information and to interoperate successfully in an automated hair cutting system. Sensing of cutter head position using optical, magnetic, ultrasonic, or other sensing techniques may allow cutter heads to be substantially precisely controlled, may allow the amount of hair in a cutter head to be sensed prior to a cutting stroke, may allow the presence of things in cutter heads that are not hair to be sensed, and may allow incorrect operation or damage of a cutter head or a cutter head sensor to be detected. Precision tolerances and manufacturing of cutter heads may include one or more positions at which sensors may be calibrated to avoid the need for precise placement of sensors.

### BRIEF DESCRIPTION OF THE DRAWINGS

FIG. 1 is an environmental view of an automated hair cutting system having a positioning device, a hair cutting device and an electronic computing device;

FIG. 2 is a perspective view of a hair cutting device having features suitable for use in an automated hair cutting system as shown in FIG. 1;

FIG. 3 is a schematic block diagram of an embodiment of an automated hair cutting system having interconnections between an electronic computing device, positioning device, and a hair cutting device;

FIG. 4 is a perspective view of one embodiment of a cutter head for use in hair cutting devices for automated hair cutting systems;

FIG. 5 is an exploded view of one embodiment of a cutter head according to the present disclosure, including various sensing elements;

FIG. 6A is a schematic view of certain features of one embodiment of a cutter head assembly according to the present disclosure;

FIG. 6B is a schematic view of other features of another embodiment of a cutter head assembly according to the present disclosure;

FIG. 7 illustrates one embodiment of data output from an embodiment of a position sensor for use with a cutter head and hair cutting system according to the present disclosure;

FIG. 8 is a system diagram of one embodiment of a control system for a cutter head according to the present disclosure; and

FIG. 9 is a flow chart of an embodiment of a cut safety control for substantially safe control of a cutter head cut for an automated hair cutting system.

### DETAILED DESCRIPTION

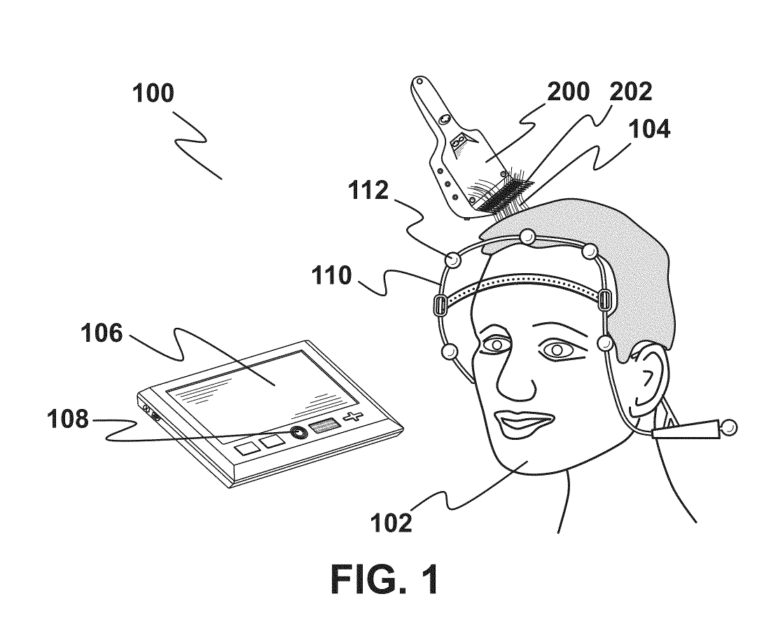

FIG. 1 shows an embodiment of an automated hair cutting system 100 cutting a region of hair 104 on a user 102. An electronic computing device 106 including a camera 108 may interact with a positioning device 110 having a plurality of positioning interfaces 112 and a hair cutting device 200. Hair cutting system 100 comprises a hair cutting device 200 including a cutter head 202. Hair cutting system 100 is described in more detail in Krenik '856. Hair cutting system 100 may operate through observation of and/or interaction with user 102 and/or positioning device 110 by hair cutting device 200 and/or other system elements to substantially allow the position and/or orientation of hair cutting device 200 to be determined relative to the head of user 102 so that selected regions of hair 104 may be substantially collected in a cutter head 202 of hair cutting device 200, extended to a beneficial length, and cut. Additional embodiments, modes of operation and additional description of automated hair cutting system 100 may be found in Krenik '856. Certain embodiments of automated hair cutting system 100 are possible in which no positioning device 110 is utilized and the position and/or orientation of hair cutting device 200 relative to the head of user 102 is determined through use of some combination of cameras, motion sensors, accelerometers, gyroscopes, and other sensors. Embodiments of automated hair cutting system 100 that do not include an electronic computing device 106 are also possible. For such embodiments, computation, display, and operator interfaces may be incorporated into hair cutting device 200 or other possible system elements.

As shown in FIG. 1, multiple modes of operation for a cutter head 202 may be desired in automated hair cutting systems 100. Commonly available hair cutters (including hair clippers, trimmers, vacuum trimmers, etc.) utilize cutter heads that are normally actuated continuously and cut hair substantially immediately as it is introduced into their cutter heads. In contrast, automated hair cutting system 100 may require that a region of hair 104 be collected in a cutter head 202 while the cutter head is close to the user's 102 scalp, so that the location of the collected region of hair 104 may be determined, the region of hair 104 may then slide through the cutter head 202 while it is extended to a beneficial length, and finally, the region of hair may be cut once a beneficial length is reached. Instead of cutting a region of hair 104, it is also possible to use automated hair cutting system 100 to substantially measure the length of region of hair 104. Knowledge of the length of hair of a user 102 may be beneficial for some embodiments as it allows automated hair cutting system 100 to advise a user 102 about possible hair styles based on hair length. It should be clear that the commonly available cutter heads of today do not provide the functions and capability that enable beneficial operation of some embodiments of an automated hair cutting system 100.

The benefit of special cutter heads 202 for hair cutting devices 200 used in an automated hair cutting system such as system 100 may be understood through an example of cutting hair along a hair part. Referring to FIG. 1, if user 102 has a part in their hair (that is, a common hair part where hair is combed in different fashions on either side of a line-like part of the hair; although not shown in FIG. 1), the location of the hair part may be indicated to an automated hair cutting system 100 by placing the front edge of the cutter head 202 of hair cutting device 200 into the part and signaling to the automated hair cutting system 100 (through a button press, touch to a button on electronic computing device 106, or other possible signal). This may be repeated at several locations along the hair part so that the automated hair cutting system 100 has a complete reference for the location of the hair part. Automated hair cutting system 100 may then direct the user 102 to comb the cutter head 202 of hair cutting device 200 up to the edge of the hair part from one side and extend hair for cutting. Automated hair cutting system 100 may monitor when the edge of the hair part is reached and signal to user 102 to stop a forward combing action and begin an extending action to extend hair for cutting. As hair may need to be cut to various lengths along a hair part and to different lengths on either side of a hair part, an automated hair cutting system 100 may monitor the location of cutter head 202 of hair cutting device 200 each time hair is extended. Especially for persons with fine hair or curly hair that may otherwise be difficult to manipulate and may easily fall out of a cutter head, and for the case of cutting hair along a hair part or other feature that requires substantially precise separation and manipulation of hair so that it may be substantially precisely cut, a cutter head with the ability to collect hair in a specific location on a user's 102 head, extend hair and possibly apply friction to it so that it doesn't fall out of the cutter head inadvertently, and cut hair at an appropriate length of extension is highly beneficial.

While embodiments of cutter heads described in this disclosure have sensing apparatuses and features which provide particular benefit for use with an automated hair cutting system 100, the embodiments described herein may also be used with hair cutting devices that are not utilized as part of an automated hair cutting system 100 or are being operated in a manual fashion without benefit of an automated hair cutting system 100.

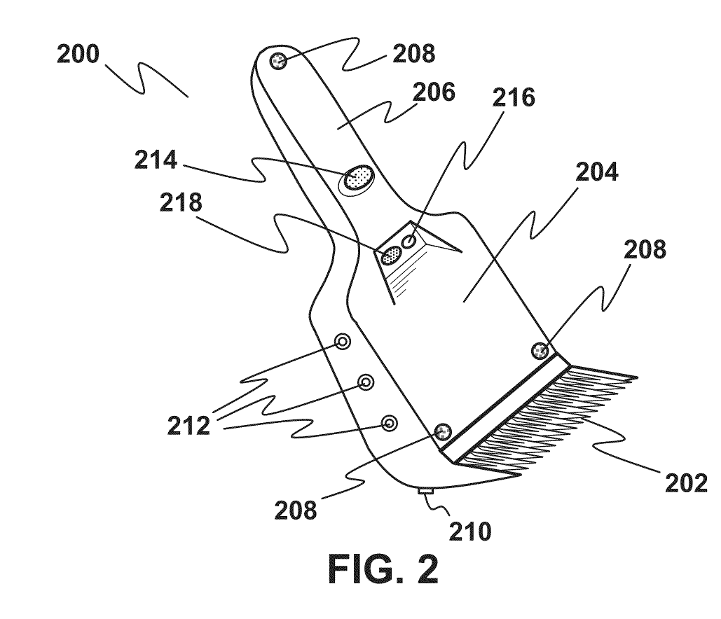

FIG. 2 shows another embodiment of a hair cutting device 200 including cutter head 202, handle 206, body 204, touch sensor 210, sensors 208, indicator lights 212, camera 216, illumination source 218, and button 214. Hair cutting device 200 operates in automated hair cutting system 100 as described above to collect hair in cutter head 202 and cut it at substantially beneficial times when the collected hair is at a beneficial length. Handle 206 and body 204 provide the main physical structure of hair cutting device 200. Touch sensor 210 allows hair cutting device 200 to monitor when it touches the scalp of a user 102 and may offer additional capability to measure distance from the scalp of user 102 to hair cutting device 200.

Some embodiments of touch sensors may also provide variable resistance and/or may provide information on the level of pressure that such a touch sensor may measure when pressed against the scalp of a user 102 so that hair cutting device 200 may receive information from such a touch sensor that may indicate the firmness, stiffness, or hardness of the scalp where it is touching. Such information about the firmness, stiffness, or hardness of a given location on a user's 102 scalp may allow an automated hair cutting system to compensate for the nature of the scalp in making determinations on when hair has been extended to a beneficial length and may be cut. For example, regions of a user's scalp that are firmer and less compliant may spring upward less as hair cutting device 200 is lifted away from a user's 102 scalp, so knowledge that a given region of a user's 102 scalp is softer and more compliant or harder and less compliant may be beneficial to some automated hair cutting systems.

Sensors 208, camera 216, and illumination source 218 may provide information beneficial information for determining the position and/or orientation of hair cutting device 200 through interaction with or observation of user 102 and/or positioning device 110. Sensors 208 may receive positioning signals generated at positioning interfaces 112, with analysis of those signals providing information beneficial for the determination of the position and/or orientation of hair cutting device 200. In some embodiments, positioning signals may be generated on hair cutting device 200 with sensors 208 and received by positioning interfaces 112. Hair cutting device 200 may also include accelerometers, gyroscopes, motion indicators, and other sensors to help in determining the position and/or orientation of hair cutting device 200 with respect to the head of user 102. Indicator lights 212 may provide beneficial signals to a user 102 in the course of operation of automated hair cutting system 100, and button 214 may allow user 102 to stop action of hair cutting device 200 in the event that user 102 no longer wants cutting action to occur or to provide other beneficial signals to automated hair cutting system 100. In some embodiments of hair cutting devices 200, button 214 may also be utilized to allow user 102 to indicate to automated hair cutting system 100 that hair has been collected in cutter head 202 and that cutter head 202 is against the scalp of user 102, so that the position and/or orientation of cutter head 202 may be determined by automated hair cutting system 100 and extension of hair may begin. Further description of embodiments of hair cutting devices are found in Krenik '856.

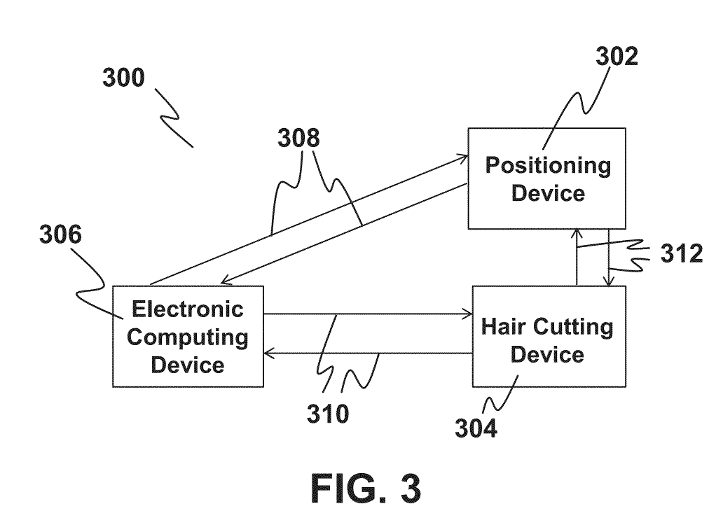

FIG. 3 shows an embodiment of an automated hair cutting system 300 including an electronic computing device 306, a hair cutting device 304, and a positioning device 302. Electronic computing device 306, hair cutting device 304, and positioning device 302 perform similarly to electronic computing device 106, hair cutting device 200, and a positioning device 110 shown in FIG. 1. In FIG. 3, communication links between the elements are shown in more detail. First communication link 308 is between electronic computing device 306 and positioning device 302; second communication link 310 is between electronic computing device 306 and hair cutting device 304; and third communication link 312 is between hair cutting device 304 and positioning device 302. First communication link 308, second communication link 310, and third communication link 312 are shown as bi-directional communication links in FIG. 3, but some embodiments of automated hair cutting systems 300 may include some communication links that convey information in one direction only. First communication link 308, second communication link 310, and third communication link 312 may be wired or wireless links, and wireless implementations of these communication links may include use of electromagnetic signals, optical signals, sound signals, ultrasonic signals, infrared signals, or other beneficial signals. Some wireless or wired embodiments of the communications links shown in FIG. 3 may implement standard protocols such as BLUETOOTH®, BLUETOOTH® Low Energy, ZIGBEE®, Universal Serial Bus (USB), THUNDERBOLT®, and other communication protocols.

First communication link 308, second communication link 310, and third communication link 312 may be operated at voltage, current, and power levels that are sufficiently low so that exposure levels and potential safety hazards to user 102 in an automated hair cutting system 100 are at substantially safe and harmless levels. Positioning signals used between positioning interfaces 112 and sensors 208 (as shown in FIGS. 1 and 2) may also be utilized at power levels that are safe for a user 102. Some embodiments of automated hair cutting systems 100 may use power control techniques, limited duty cycles, and other techniques to reduce exposure of user 102 to signals used for communications links and positioning.

During operation of automated hair cutting system 300, certain communication links operate at critical times. For example, electronic computing device 306 may include a touch screen button, keyboard press option, voice command, or other user input option to stop cutting action of hair cutting device 304. Stopping cutting action may arise for various reasons, such as, inter alia, undesired or unexpected cutting results, an injury or emergency has occurred, or a safety risk is present. Hence, electronic computing device 306 may need to send a stop signal to hair cutting device 304 over second communication link 310. However, if second communication link 310 is a wired or wireless link that is not operating reliably for any reason, an emergency stop signal from electronic computing device 306 may not actually be received by hair cutting device 304. Alternatively, a fail-safe communication technique between electronic computing device 306 and hair cutting device 304 may require that before hair cutting device 304 cuts hair, that it sends a “request-to-cut” signal to electronic computing device 306 and only cuts hair if it receives an “okay-to-cut” signal back from electronic computing device 306. For some embodiments, the requirement to send requests and acknowledgements over communications links may be too slow and burdensome. However, alternatives exist that do not require such a burden. For example, in some embodiments, electronic computing device 306 might send an “all is okay” signal on a regular basis, such as a time interval of every 10 milliseconds, or other suitable time intervals, to hair cutting device 304 unless an emergency situation is present. Accordingly, if second communication link 310 is broken or experiences interference, hair cutting device 304 will recognize the loss of the “all is okay” signal from electronic computing device 306 and stop cutting action (regardless of whether there is a real emergency situation or if the communication link simply failed).

In some embodiments, reliability of the third communication link 312 between positioning device 302 and hair cutting device 304 may be a key feature. Even if hair cutting device 304 is receiving positioning signals through its sensors and determining its position, errors may be occurring if positioning device 302 is not operating correctly. Hence, hair cutting device 304 may send a “start sequence” or other command to positioning device 302 over third communication link 312 and positioning device 302 may respond either with a sequence of positioning signals, and/or an “acknowledgement” signal over third communication link 312 so that hair cutting device 304 is assured that positioning device 302 is operating properly.

Reliability of first communication link 308 may also be a key feature of other embodiments. For example, if the position and/or orientation of hair cutting device 304 is computed in positioning device 302, positioning device 302 may need information from electronic computing device 306, such as camera images for example, to most reliably complete the position and/or orientation computations.

Those skilled in the art will recognize that the functions necessary for automated hair cutting system 300 to operate may be partitioned into the elements of the system differently for various embodiments. For example, the position and orientation computations for hair cutting device 304 and the decision of when to actuate the cutter head of hair cutting device 304 may take place in hair cutting device 304, in electronic computing device 306, or in positioning device 302. Hence, what information is communicated across the communication links shown in FIG. 3 in the course of operation of automated hair cutting system 300 and how that information is secured, encoded, and acknowledged is important in ensuring reliable and safe operation. Those skilled in the art will recognize that principles of fail-safe design, secure communications, information encoding, and other beneficial design principles may be applied to various embodiments of an automated hair cutting system 300 to ensure safe and reliable operation.

In addition to potentially unsafe or undesirable operation in the event of failure of first communication link 308, second communication link 310, or third communication link 312, it is also possible for electronic computing device 306, hair cutting device 304, positioning device 302, or other possible system elements to fail and cause unsafe or undesirable system behavior. Accordingly, appropriate design principles for fail-safe design may be applied to various embodiments including the use of watchdog timers, system self-testing, system self-calibration, redundant systems, automatic detection of miss-use or miss-application of one or more system elements, requests and acknowledgements, and other techniques to ensure safe and desirable operation. And given the potential for computer viruses, malicious computer code, and other possible harmful software, some embodiments may also include virus detection/correction software and/or software to stop operation or correct software in the event of a malicious attack or corruption of a system's software.

In the course of operation of some possible embodiments of automated hair cutting system 300, system elements may be synchronized in time. First communication link 308, second communication link 310, and third communication link 312 may provide synchronization of electronic computing device 306, hair cutting device 304, and/or positioning device 302. Synchronization may be undertaken in a variety of ways. One possible solution is to send a “token” from one device to the next with a pre-defined delay at each device, so that when a device receives the “token” it may infer a substantially precise time. For example, electronic computing device 306 may initiate synchronization by sending a “token” (such a “token” here is simple a communication signal, data word, or other electronically recognizable signal or message that is known by the receiving device to be for the purpose of synchronization) over second communication link 310 to hair cutting device 304. Hair cutting device 304 may receive the token, wait a pre-defined time interval, and send the token on to positioning device 302 over third communication link 312. Positioning device 302 may also wait a pre-defined time interval and then send the token on to electronic computing device 306 over first communication link 308. Once electronic computing device 306 receives the token, it may check the substantially precise time using a substantially precise timing function inside electronic computing device 306 to confirm that the token has been passed from itself to hair cutting device 304 to positioning device 302 and back to itself with correct timing. Accordingly, electronic computing device 306 may confirm that all devices in automated hair cutting system 300 are now substantially operational and synchronized within acceptable tolerances and that system operation may continue. If electronic computing device 306 detects a fault, electronic computing device 306 may take appropriate action to halt operation, alert the user, or take other actions for stopping operation of automated hair cutting system 300.

Precise synchronization may not be required for certain types of data and control signals. In some embodiments, for example, tight synchronization may be required between positioning device 302 and hair cutting device 304 (to aid in precise position and orientation information); but communications between electronic computing device 306 and hair cutting device 304 or positioning device 302 may be limited to information or commands that do not require synchronization. For such an embodiment, electronic computing device 306, or another system element, may send a token or other synchronization signal to both positioning device 302 and hair cutting device 304 at substantially the same time so that they become substantially synchronized when they receive it. In the case of a system using wireless interfaces, a beacon signal (such as a timing pulse or other signal) may be sent by electronic computing device 306 or another system element to synchronize positioning device 302 and hair cutting device 304 to each other. Additional embodiments may also comprise a beacon signal sent by positioning device 302 or hair cutting device 304. Those skilled in the art will recognize that a wide range of system embodiments are possible to provide synchronization between the elements of automated hair cutting system 300.

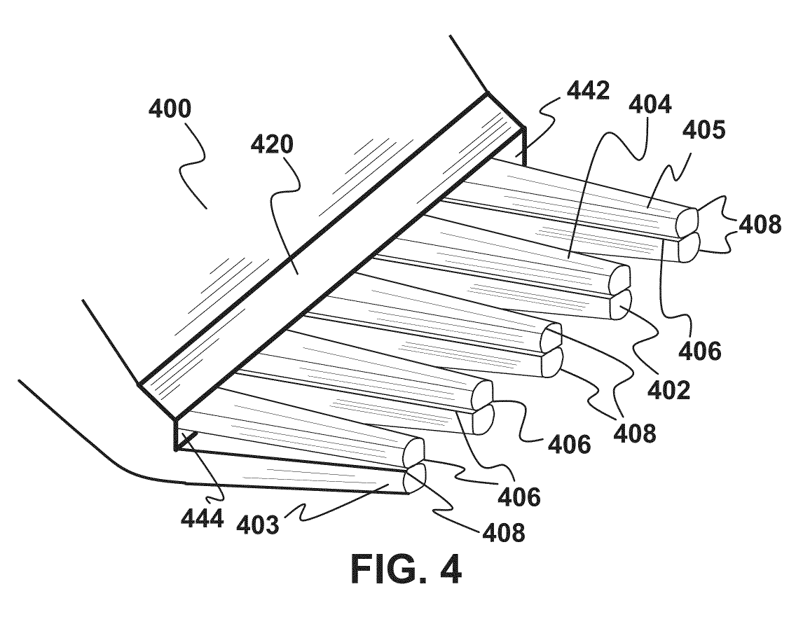

FIG. 4 shows an embodiment of a cutter head 400 for use in hair cutting devices for automated hair cutting systems. Cutter head 400 enables hair to be collected during cutting. Cutter head 400 comprises cutter knives 404, which when actuated in a first direction, apply pressure and friction to hair for beneficial manipulation, and provides cutting action when the cutter knives 404 are actuated in a second direction. Cutter head 400 of FIG. 4 includes cutter knives 404, comb teeth 402, and body 420. Cutter head 400 may be actuated so that cutter knives 404 are substantially above comb teeth 402 so that hair may be collected in cutter head 400 (the view of FIG. 4 shows cutter knives 404 in such a position). Cutter head 400 may be actuated so that cutter knives 404 move to the left (toward the lower left corner of FIG. 4) whereby rounded edges 408 of cutter knives 404 and comb teeth 402 apply pressure to hair collected in cutter head 400. Application of pressure to hair collected into cutter head 400 may provide improved manipulation of hair collected in cutter head 400 because resulting friction may help keep hair in cutter head 400. Cutter head 400 may be actuated so that cutter knives 404 move to the right (toward the upper right corner of FIG. 4) so that sharp edges 406 of cutter knives 404 and comb teeth 402 meet and pass over each other to provide a cutting action (much as the blades of a common pair of scissors pass over each other to provide cutting action). Left most comb tooth 403 and right most cutter knife 405 have only rounded edges 408 and have no sharp edges 406 as left most comb tooth 403 and right most cutter knife 405 are not utilized for cutting hair during a cutting stroke of cutter head 400. Gap 442 and gap 444 provide spacing between cutter knives 404 (including right most cutter knife 405) and body 420 so that they may move to the right and left. Cutter head 400 may be fabricated from metals, ceramics, and other suitable materials. Embodiments of cutter heads similar to cutter head 400 in FIG. 4 are provided in the related patent applications cross referenced in the first section of this patent application and in application Ser. No. 14/051,201, “Cutter Head for Automated Hair Cutting System,” filed Oct. 10, 2013. Various cutter head embodiments, including cutter head 400, may be used in conjunction with cutter head 202 as shown on hair cutting device 200.

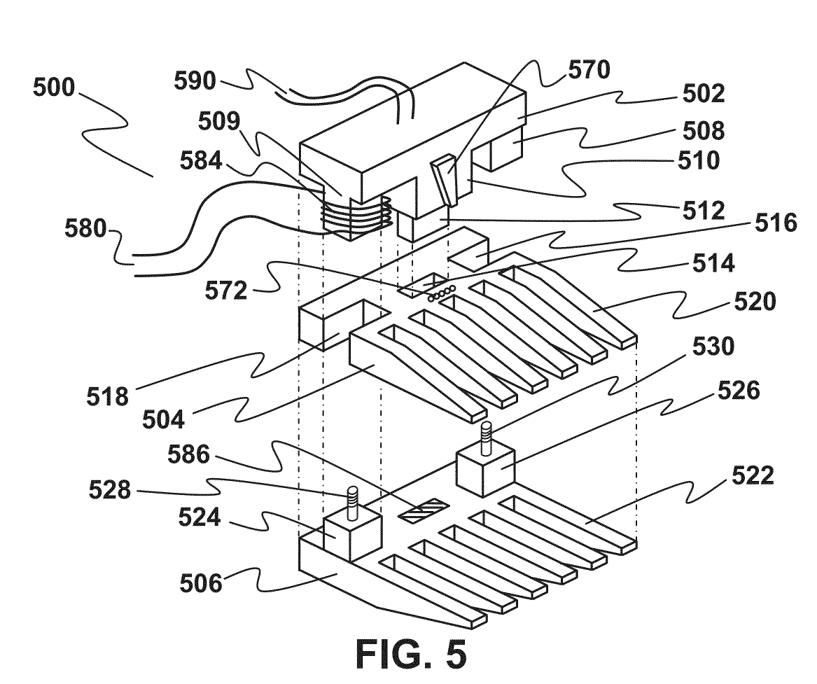

FIG. 5 illustrates embodiments of two cutter head sensing techniques. Bottom comb 506 and top cutter 504 may be actuated back and forth relative to each other by actuator 502 for cutting hair. Bottom comb 506, top cutter 504, and actuator 502 are shown separated, but during assembly of cutter head 500, bottom comb 506, top cutter 504 and actuator 502 contact each other, mating together as shown by the dashed lines in FIG. 5 so that cutter knives 520 of top cutter 504 mate with comb teeth 522 of bottom comb 506; actuating member 512 mates to top cutter slot 514; left mounting standoff 524 mates to top cutter 504 through left guide opening 518; right mounting standoff 526 mates to top cutter 504 through right guide opening 516; left mounting screw 528 engages left actuator mount 509; and right mounting screw 530 engages right actuator mount 508. Left mounting screw 528 and right mounting screw 530 extend upward through bottom comb 506 and left mounting standoff 524 and right mounting standoff 526, respectively.

Top cutter 504 and bottom comb 506 are shown in FIG. 5 with substantially flat and planar mating surfaces. However, those skilled in the art will recognize that some embodiments may benefit from substantially thinner top cutters and bottom combs and that, for some such embodiments, use of top cutters and/or bottom combs that have mating surfaces that are substantially somewhat concave or convex may be beneficial so that compressive pressure from left mounting screw 528, right mounting screw 530, actuator housing 510, or other elements as may be found in various embodiments may be distributed across the mating surfaces of top cutters and bottom combs so that substantially more intimate contact may occur. Those skilled in the art will recognize that some cutting tools such as scissors commonly make use of concave mating surfaces between cutting elements so that intimate contact of cutting edges is established and maintained through the course of a cutting cycle. Hence, the use of specially formed or shaped top cutters and bottom combs using concave mating surfaces, convex mating surfaces, or other shapes or types of mating surfaces for various embodiments is possible.

Actuator 502 shown in FIG. 5 may be a voice coil actuator, stepper motor, solenoid actuator, an actuator formed with a motor with gears/levers/etc., piezo actuator, or any other type of suitable actuator or combinations of actuators. Those skilled in the art will recognize that very many types of actuators, combinations of actuators, and mechanical implementations including gears, levers, etc. may be used to provide a beneficial actuation of possible cutter head embodiments, including cutter head 500. Actuator control wires 590 indicate that actuator 502 may be controlled electrically through analog, digital, or other forms of control across one or more electrical wires.

Additional actuators may be used in some embodiments of cutter head 500. For example, as top cutter 504 is actuated on a cutting stroke, it may be beneficial to provide some level of force in a fashion to compress top cutter 504 and bottom comb 506 together more tightly than the level of force provided by left mounting screw 528 and right mounting screw 530. Compressing top cutter 504 and bottom comb 506 more tightly together on a cutting stroke may improve the effectiveness of cutter knives 520 and comb teeth 522 to intimately pinch and cut hair. Relaxing compression of top cutter 504 and bottom comb 506 when cutting head 500 is not in a cutting stroke may allow reduced friction, smoother operation, and lower power levels. Hence, an additional actuator or a lever, cam, or other element that provides a compressing force between top cutter and bottom comb during a cutting stroke may provide benefit for some embodiments. In some embodiments, use of magnetic coils such as coil 584 to provide a magnetic field through some elements of cutter head 500 may also be used to apply a magnetic compressing force between top cutter 504 and bottom comb 506.

Compressive pressure between top cutter 504 and bottom comb 506 may also be produced for some positions of top cutter 504 relative to bottom comb 506 through the addition of surface features on the mating surfaces of top cutter 504, bottom comb 506, and/or housing 510. For example, a ridge, ramp, wedge, or other feature on the top surface of top cutter 504 may engage actuator housing 510 in the course of a cutting stroke to apply compressive pressure between top cutter 504 and bottom comb 506. Those skilled in the art will recognize a wide range of possible machined features, cams, gears, eccentric gears, and many other features that may be used to apply compressive pressure between top cutter 504 and bottom comb 506 at desired positions along the possible range of motion of top cutter 504 in the course of actuation of cutter head 500.

Cutter knives 520 and comb teeth 522 shown in FIG. 5 have square edges, but those skilled in the art will recognize that embodiments using cutter knives and comb teeth similar to those shown on cutter head 400 of FIG. 4, or other possible embodiments of cutter knives and comb teeth may be used in various embodiments of cutter head 500.

The embodiment of cutter head 500 as shown in FIG. 5 demonstrates both magnetic and optical position sensing. As explained with regard to cutter head 400 of FIG. 4, and cutter head 202 of FIGS. 1-2, some embodiments of cutter heads for automated hair cutting systems require alignment of cutter knives and comb teeth so that hair may be collected into a cutter head.

Collection of hair in a cutter head may be followed by altering the position of cutter knives to change cutter head spacing or to apply pressure and friction to hair, and a cutting stroke to cut hair may also follow. Hence, cutter heads for automated hair cutting systems may benefit from sensors that may sense position of cutter knives relative to comb teeth so that cutter knives may be beneficially controlled using feedback control loops. Embodiments of cutter heads in automated hair cutting systems 100 in which a cutter head is controlled utilizing open loop controls are also possible. Such cutter heads may be controlled by stepper motors or other elements suitable for open loop controls.

In FIG. 5, coil 584 may generate a magnetic field in left actuator mount 509 in response to electrical current provided to coil 584 from coil wires 580. In some embodiments of cutter head 500, left actuator mount 509, left mounting standoff 524, left mounting screw 528, bottom comb 506, actuating member 512, some portions of actuator 502 and actuator housing 510 may be constructed from substantially magnetically permeable materials so that a magnetic circuit through these elements is established and so that magnetic flux from coil 584 flows in this magnetic circuit. Those skilled in the art will recognize that magnetic flux will favor this magnetic circuit versus other elements of cutter head 500 if those other elements (top cutter 504, right mounting standoff 526, right actuator mount 508, etc.) are fabricated from substantially non-magnetically permeable materials. Bottom comb insert 586 may be an insert bonded into an opening in bottom comb 506 and may be fabricated from metals, ceramics, plastics, or other materials with controlled magnetic reluctance so that as actuating member 512 moves to the left and right as top cutter is actuated, the overlap of bottom comb insert 586 and actuating member 512 changes (note that actuating member 512 may extend through top cutter 504 and may either touch or have beneficial spacing to bottom comb insert 586). For such an embodiment, as top cutter 504 is actuated to the left and right, the inductance presented on coil wires 580, may change in response to the position of top cutter 504 relative to bottom comb 506 so that position sensing may be achieved. Those skilled in the art will recognize a very wide range of possible approaches for magnetic sensing of the position of top cutter 504 relative to bottom comb 506 including techniques that make use of transformers, multiple coils, regions of magnetic and non-magnetic materials in various elements of cutter head 500, use of magnetic and non-magnetic materials for the fabrication of various elements of cutter head 500, inductive sensors, eddy current sensors, magnetic loss sensors, magnetic proximity sensors, specially machined parts or surfaces that change magnetic reluctance in response to their positions, permanent magnets embedded in some elements of cutter head 500, and many other common techniques that are widely used in the application of magnetic techniques to position sensing. Magnetic sensors such as Linear Variable Differential Transformers (LVDT), inductive sensors, Hall-effect sensors, and other magnetic position sensors may also be attached to the structure of cutter head 500 to sense the position of top cutter 504.

Cutter head 500 in FIG. 5 also includes optical sensor 570 and optical targets 572 that may interact to provide position sensing of top cutter 504 relative to bottom comb 506. Optical sensor 570 may include Light Emitting Diodes (LED), laser diodes, infrared diodes, lasers, or other types of light sources along with photodiodes, photo-detectors, or other types of light sensors. Optical targets 572 may be reflectors, pits in the surface of top cutter 504, features etched or machined in the surface of top cutter 504, or other possible features that may interact with the elements of optical sensor 570 so that the position of top cutter 504 relative to bottom comb 506 may be measured. Those skilled in the art will recognize a wide range of possible optical position sensing techniques that may be applied to embodiments of cutter head 500.

Those skilled in the art will recognize that while the embodiment of cutter head 500 as shown in FIG. 5 includes a magnetic positioning sensing and an optical position sensing capability, that many other embodiments of cutter heads for automated hair cutting systems 100 may make use of a very wide variety of position sensing technologies. Common position sensing technologies including magnetic sensing, optical sensing, sensing with infrared light, sensing with ultrasonic signals, use of linear position encoders, and many other common position sensing techniques may be applied. Multiple cutter head position sensing technologies may be used in conjunction in some embodiments either to provide redundant position signals for safety or reliability purposes, or to enhance performance. Performance enhancements might be achieved, for example, if magnetic sensing such as a Linear Variable Differential Transformer (LVDT) is used for precise positioning and optical sensing is used for position sensing during fast cutting strokes. Clearly, many possible embodiments for sensing cutter knife position exist.

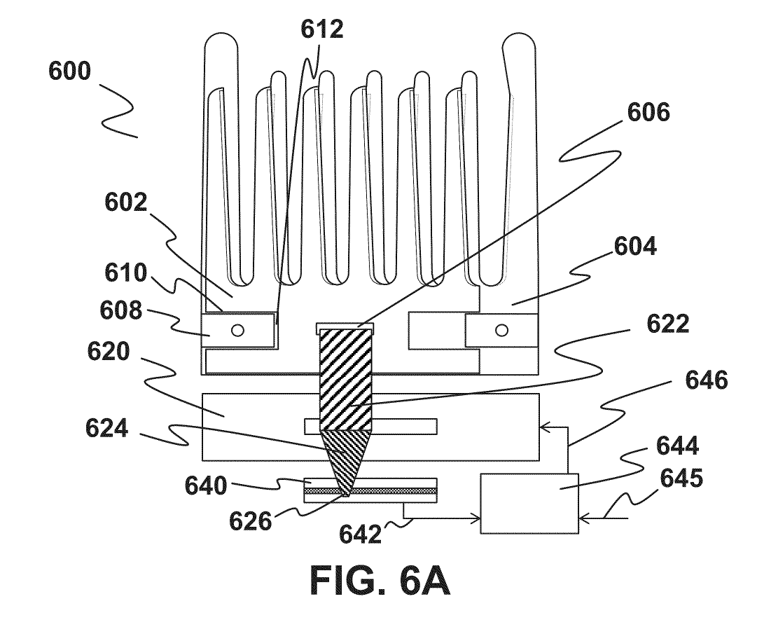

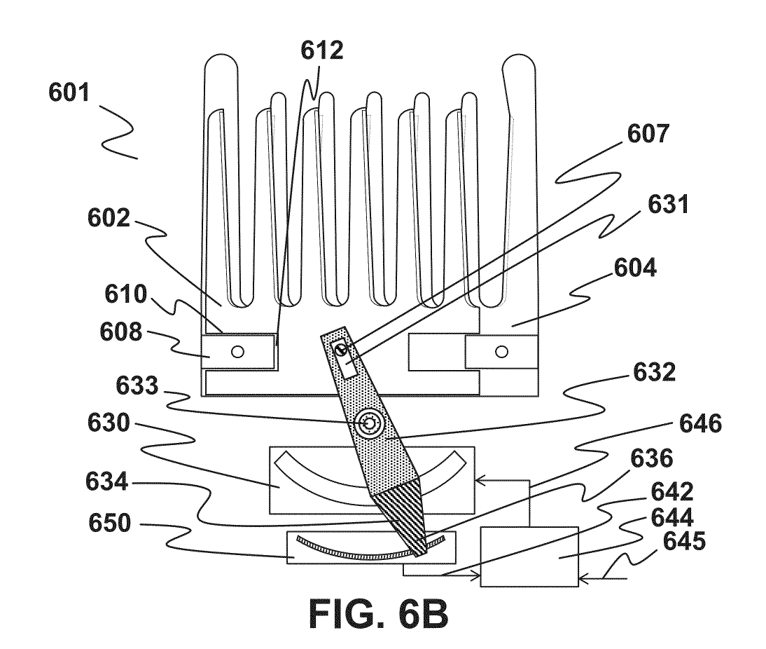

FIG. 6A shows a schematic view of an embodiment of a cutter head assembly 600 including a top cutter 602 with top cutter slot 606 and guide opening 610, a mounting standoff 608, a bottom comb 604, a connecting member 622, a connecting member extension 624 with tip 626, an actuator 620, a position sensor 640, and an actuator control 644. Top cutter 602 is shown on top of and mating with bottom comb 604 in FIG. 6A in an analogous fashion to how top cutter 504 and bottom comb 506 would mate together as shown in FIG. 5 if the exploded view of FIG. 5 were collapsed so that the elements shown mated together as previously described. Position signal 642 provides information from position sensor 640 to actuator control 644. Actuator control signal 646 provides control commands from actuator control 644 to actuator 620. Actuator control 644 receives input signals from input port 645 and controls top cutter 602 in response. Input port 645 may provide signals from other electronics in a hair cutting device 200 or other elements of an automated hair cutting system 100. Signals received by actuator control 644 from input port 645 may include signals to position top cutter 602 to collect hair, signals to adjust the position of top cutter 602 to partially compress hair and apply some level of friction to it, signals to cut hair, signals to apply braking, signals to vibrate top cutter 602, and other possible signals. Actuator 620 may comprise any type of actuator suitable to drive top cutter 602.

Connecting member 622 extends laterally from actuator 620 to top cutter slot 606 and transfers motion from actuator 620 to top cutter slot 606 and so also transfers motion to top cutter 602. In other embodiments, actuator 620 may be positioned above top cutter 602 or may be positioned in other configurations. In some embodiments, connecting member 622 may be a physical part of actuator 620 or may be formed as a component of actuator 620. Connecting member 622 may also be a separate element that is screwed, bolted, welded, glued, snapped together with, or otherwise affixed to actuator 620. The embodiment of FIG. 6A shows connecting member 622 engaging top cutter slot 606, but those skilled in the art will recognize that alternatives for attaching connecting member 622 to top cutter 602 are possible, such as including attaching with screws, bolts, welds, glue, rivets, or other techniques. An intermediate hub, coupler, fixture, bearing, or other intermediate coupler may also be present in some embodiments between connecting member 622 and top cutter slot 606.

Connecting member 662 may provide pressure to top cutter 602 in some embodiments so that top cutter 602 is more strongly pressed against bottom comb 604. Such pressure to top cutter 602 may be substantially constant through the course of actuation of top cutter 602 or may be variable depending on the position of top cutter 602. Connecting member extension 624 may be part of connecting member 622 or may attach to connecting member 622. Connecting member extension 624 extends the motion of connecting member 622 to position sensor 640 so that position sensor 640 may sense the motion of top cutter 602. Connecting member extension 624 has tip 626 so that position sensor 640 may provide a substantially precise reading of the position of tip 626 and so provide a precise reading of the position of top cutter 602. Position sensor 640 may be based on optical, magnetic, ultrasonic, radar, sonar, electrostatic, resistive, or other principles. Those skilled in the art will recognize that a wide variety of position sensors, connecting member extensions or other techniques through which motion of top cutter 602 may be transferred to a position sensor are possible. In some embodiments, top cutter 602 may include features so that it may be sensed directly (as explained with regard to FIG. 5, for example) instead of through connecting member 622 and connecting member extension 624. Additionally, a top cutter or connecting member may be sensed through motion transferred through connecting member extensions, levers, gears, reflected light, electromagnetic signals, or any other possible way to transfer motion so that it may be sensed. Position sensing may also be achieved with a wide variety of sensing techniques including techniques that may involve placement of a light, light emitting diode (LED), magnet, or other signal generating element on a top cutter 602 or through a technique to transfer motion from a top cutter so that a generated signal may be received by a sensor, an array of sensors, or other sensing techniques.

Position sensor 640 provides position signal 642 to actuator control 644. Actuator control 644 may include analog electronics, amplifiers, filters, analog-to-digital converters, digital electronics, microcontrollers, memory, data processing functions, power electronics, transistors, capacitors, resistors, relays, and other possible electrical, electro-mechanical, or electronic components. In some embodiments, actuator control 644 may be a part of another element of a hair cutting device and its functions may be performed by electronic functions that also provide other computational, control, or other functions for a hair cutting device (such as hair cutting device 200). Actuator control 644 may also include electronic communications interfaces, communications ports, power connections, and other connections that are not shown in FIG. 6A, but may be beneficial in some embodiments of actuator control 644. Actuator control 644 generates actuator control signal 646. Actuator 620 may be responsive to actuator control signal 646. Actuator control signal 646 may, for various embodiments, indicate a desired direction of motion, a desired level of force, a desired position, and/or other information beneficial to control actuator 620.

Those skilled in the art will recognize that some embodiments of top cutter 602 and bottom comb 604 may be fabricated with precision equipment such as milling machines, laser cutting machines, computer controlled fabrication equipment, precision stamping machines, or other precision equipment. Hence, tolerances of top cutter 602 and bottom comb 604 may be substantially precise. Additionally, those skilled in the art will recognize that transferring motion from top cutter 602 through a connecting member 622, connecting member extension 624, or through other possible means may result in some loss of precision due to the tolerances of the elements through which motion is transferred. And additionally, position sensor 640 may not be precisely positioned and its precise location relative to top cutter 602 may also be subject to a number of tolerances.

The embodiment of FIG. 6A of cutter head assembly 600 provides a method of calibration to allow substantially precise tolerances of top cutter 602 and bottom comb 604 to be extended to position sensor 640. Actuator control 644 may direct actuator 620 to provide force on top cutter 602 to move top cutter 602 to a substantially precisely known position. In FIG. 6A, top cutter 602 has been actuated substantially to the left so that mounting standoff 608 and guide opening 610 are fully engaged and top cutter 602 has closed gap 612 between mounting standoff 608 and guide opening 610 to a substantially minimal amount. Since guide opening 610 and mounting standoff 608 may be substantially precisely formed as parts of top cutter 602 and bottom comb 604, the position of top cutter 602 relative to bottom comb 604 may be substantially precise as shown in FIG. 6A. With top cutter 602 positioned as shown in FIG. 6A, actuator control 644 may read position signal 642 and note that the level or reading of position signal 642 corresponds to the substantially precise position of top cutter 602 as shown in FIG. 6A. Subsequent readings of position signal 642 may use this initial reading of position signal 642 as a point of reference or calibration so that substantially higher levels of precision of the position of top cutter 602 may be achieved. For some embodiments, such a single point of calibration of the readings of position sensor 640 through position signal 642 may be fully adequate to provide a required level of precision. Those skilled in the art will recognize that top cutter 602 may also be actuated substantially all the way to the right so that the mounting standoff and guide openings to the right side of top cutter 602 fully engage and a second point of calibration may be taken to substantially further improve precision. And some embodiments of cutter heads, regardless of whether they are formed in the fashion of cutter heads shown in this patent application or have other structure, may use similar techniques to utilize known positions of a cutter head for calibration of a position sensor or sensors so that overall precision may be improved.

Guide opening 610 and mounting standoff 608 as shown in FIG. 6A are of rectangular shape so that gap 612 is formed from two flat surfaces (flat surfaces of guide opening 610 and mounting standoff 608) at close proximity. Those skilled in the art will recognize that debris or other contamination that may be present in a cutter head of a hair cutting device may collect in a gap such as gap 612 and that build-up of debris or other contamination in gap 612 may lead to a loss of accuracy through the calibration technique described above. Hence, instead of forming a gap 612 from flat surfaces at close proximity, mounting standoff 608 and/or guide opening 610 may present a triangular, trapezoidal, or pointed face to gap 612 so that the presence of debris or contamination is substantially less likely to result in a loss of accuracy. Those skilled in the art will recognize that many common techniques for shaping precision parts to avoid accuracy loss due to debris or contamination may be utilized to generate multiple embodiments in addition to the embodiment shown in FIG. 6A.

Those skilled in the art will recognize that motion of top cutter 602 to the right during a cutting stroke may involve rapid and powerful motion that may result in collisions between the mounting standoff and guide openings on the right side of top cutter 602 in FIG. 6A that may result in wear, loss of precise alignment, and substantially loss of precision. Hence, some embodiments may favor use of the left mounting standoff 608 and left guide opening 610 for substantially precise calibration of position sensor 640. In other embodiments of cutter head assemblies certain precision features not subjected to events resulting in loss of precision may be selected for calibration purposes.

FIG. 6B shows a schematic view of an embodiment of cutter head assembly 601 that is similar to the embodiment of cutter head assembly 600 in FIG. 6A, but utilizes rotary actuation instead of the linear actuation shown in FIG. 6A. Like numbered elements of FIG. 6B perform the same functions as so numbered elements in FIG. 6A. Connecting lever 632 engages top cutter pin 607 through connecting lever slot 631. Connecting lever 632 is supported by bearing 633 and is driven by rotary actuator 630. Bearing 633 may be a ball bearing, roller bearing, a simple shaft and cylinder style of bearing, or other possible bearing. Top cutter pin 607 is a vertically standing pin protruding from the top surface of top cutter 602 and securely fixed to top cutter 602 so that rotary motion of connecting lever 632 engages top cutter pin 607 through connecting lever slot 631 so that rotary action of connect lever 632 is transferred to lateral motion of top cutter 602. Some embodiments of cutter head assembly 601 may make use of alternative or additional bearings, hubs, cams, or other features to facilitate smooth transfer of motion between connecting lever 632 and top cutter 602. Connecting lever 632 may provide pressure to top cutter 602 to compress top cutter 602 against bottom comb 604 in some embodiments. Connecting lever extension 634 has tip 636 that is sensed by rotary position sensor 650. Position signal 642 is generated by rotary position sensor 650 and is used by actuator control 644 to produce actuator control signal 646 which controls rotary actuator 630. Those skilled in the art will recognize that the embodiment of cutter head assembly 601 may operate in a similar fashion as cutter head assembly 600 and that embodiments including a rotary actuator 630 may provide benefit in allowing connecting lever 632 to provide mechanical advantage, allow bearing 633 to be located inside cutter head assembly 601 in a location where space for motion is limited (or, similarly, at a location inside hair cutting device 200 where space for motion is limited), provide balance and smoother actuation of top cutter 602, or provide other benefits. A substantially precise location of top cutter 602 in which gap 612 is substantially minimized may be transferred to a specific reading of position signal 642 from rotary position sensor 650 and may be utilized by actuator control 644 as a point of calibration, as may be multiple points of calibration and other benefits, as described above with reference to cutter head assembly 600.

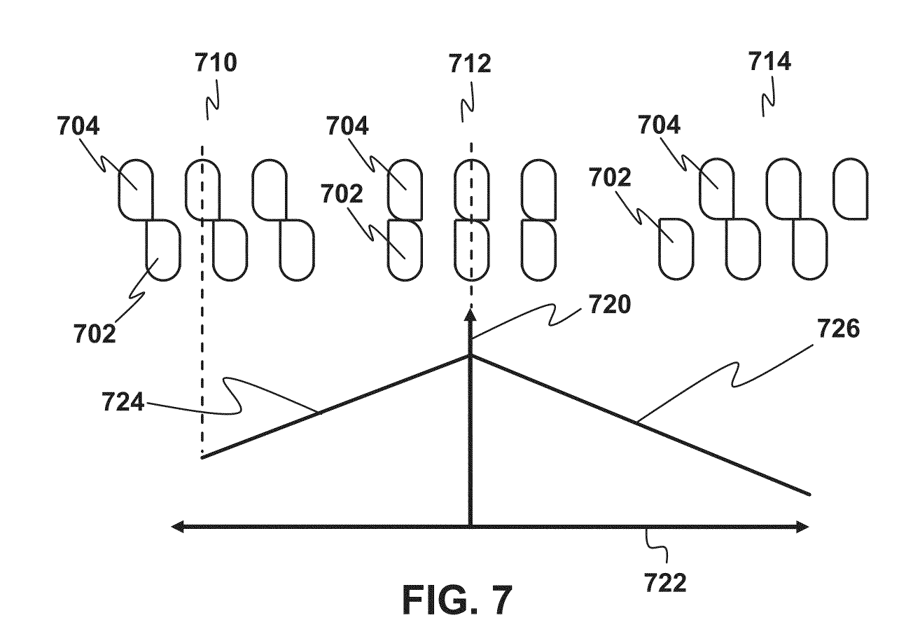

FIG. 7 illustrates how positions of cutter knives 704 relative to bottom teeth 702 may correspond to position signals such as position signal 642 shown in FIGS. 6A and 6B. Cutter knives 704 and comb teeth 702 are shown in a cross-section view and may be similar to cutter knives and comb teeth shown in other embodiments of this disclosure, such as cutter head 400 shown in FIG. 4, or other possible embodiments of cutter heads. Three relative positions of three cutter knives 704 relative to three bottom teeth 702 are shown across the top of FIG. 7. To the top left in FIG. 7, the position of left actuated cutter knives 710 is shown in which cutter knives 704 are actuated to the left relative to bottom teeth 702 so that friction may be applied to hair. To the top center in FIG. 7, the position of center actuated cutter knives 712 is shown in which cutter knives 704 are actuated directly above bottom teeth 702 so that hair may be easily collected. To the top right in FIG. 7, the position of right actuated cutter knives 714 is shown in which cutter knives 704 are actuated to the right relative to bottom teeth 702 so that hair may be cut. Across the bottom portion of FIG. 7, a chart showing relative position signals that may be generated by various embodiments of position sensors, such as those shown and described in FIGS. 5, 6A, and 6B, or other possible embodiments, are shown. Left actuated cutter knives 710 correspond to a left position signal line 724, center actuated cutter knives 712 correspond to a maximum position signal shown where left position signal line 724 and right position signal line 726 meet vertical axis 720, and right actuated cutter knives 714 correspond to a right position signal line 726. The chart in FIG. 7 provides a position indication signal in the form of left position signal line 724 and right position signal line 726 as a function of the position of cutter knives 704 relative to comb teeth 702 as plotted along the horizontal axis 722. Left position signal line 724 and right position signal line 726 may represent voltage signals, current signals, digital signals, analog signals, or other possible types of signals; and left position signal line 724 and right position signal line 726 may be generated from a wide range of position sensing techniques such as magnetic, optical, ultrasonic, or other possible position sensing techniques. And while left position signal line 724 and right position signal line 726 are shown in FIG. 7 as straight lines, that a very wide range of linear, non-linear, curved, piecewise linear, and other position signal indications may be used to represent the position of cutter knives relative to comb teeth for a wide range of possible embodiments of cutter heads, position sensing techniques, and position signals.

The cutter head position of left actuated cutter knives 710 as shown in FIG. 7 may be a beneficial position for some embodiments of cutter heads for automated hair cutting systems 100 for knives to be positioned during storage and at other times when a cutter head is not in active use. As shown, sharp edges of cutter knives 704 are positioned against flat surfaces of comb teeth 702 and sharp edges of comb teeth are positioned against flat surfaces of cutter knives 704. Such a position, or similar positions, of cutter knives 704 and comb teeth 702 may limit damage to the sharp edges of cutter knives 704 and comb teeth 702. Hence, some embodiments of automated hair cutting systems 100 may “park” cutter knives 704 in a similar position to the position of left actuated cutter knives 710 as shown in FIG. 7 and may apply electrical or mechanical braking, locks, or other functions to secure cutter knives 704 in such a position during storage, idle times, or other times in which a cutter head is not actively in use collecting, manipulating, or cutting hair.

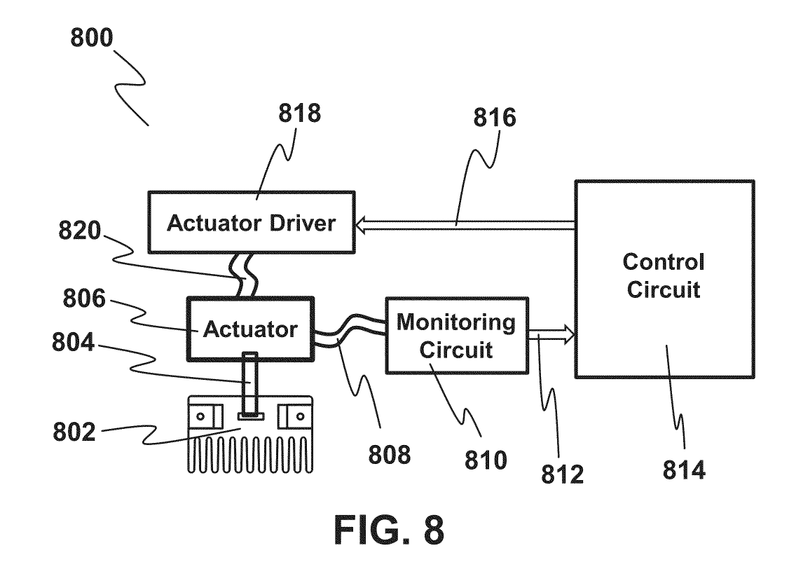

FIG. 8 shows an embodiment of a control system 800 for control of cutter knives of a cutter head for an automated hair cutting system 100. Cutter head 802 may comprise similar components and features to cutter heads shown and illustrated herein or may be an alternative embodiment suitable for use in an automated hair cutting system 100. Cutter head 802 is actuated by actuator 806 through actuating member 804. Cutter head sensor wires 808 may carry signals indicating the position of cutter knives relative to comb teeth of cutter head 802 from a position sensor inside actuator 806. Cutter head sensor wires 808 are sensed by monitoring circuit 810. Monitoring circuit 810 sends sensing signal 812 to control circuit 814. Control circuit 814 determines beneficial control for cutter head 802 based on sensing signal 812 and other inputs it may receive from automated hair cutting system 100 (through signals that are not shown in FIG. 8). Control circuit 814 sends control signal 816 to actuator driver 818 and actuator driver 818 drives actuator 806 through driver wires 820. Actuator driver 818 may also monitor actuator 806 through driver wires 820 and while FIG. 8 only shows two driver wires 820 other embodiments may contain additional wires. In some embodiments, for example, actuator driver 818 may monitor voltage and current levels of magnetic coils in actuator 806 and may form a local feedback circuit to beneficially control actuator 806.

Control system 800 may make use of many commonly used control techniques such as PID (Proportional, Integral, Differential) control, maximum deflection control, bang-bang control, linear control, non-linear control, adaptive control, and other various control systems and techniques suitable for use with the present disclosure. Control system 800 may include amplifiers, comparators, power electronics, class D amplifiers, analog-to-digital converters, digital-to-analog converters, phase locked loops, digital computation electronics, analog computation electronics, filters, oscillators, electronic memory, microprocessors, digital signal processors, and other analog and/or digital electronics. Control system 800 may implement many signal processing and control techniques including optimal estimators, Kalman filters, estimators, Fourier transforms, fast Fourier transforms, adaptive filters, filters, adaptive control, and other applicable signal processing and/or control techniques. Monitoring circuit 810 may contain amplifiers, filters, analog-to-digital converters, and other elements to condition and buffer signals on cutter head sensor wires 808 and to produce a sensing signal 812 that is suitable for reception by control circuit 814. Actuator 806 may be a magnetic actuator, voice coil motor, solenoid, or other suitable actuator. Actuator driver 818 may contain power amplifiers or other power and/or monitoring electronics.

Control system 800 may offer a wide range of flexibility for control of cutter head 802. For example, when a user desires to center the knives of cutter head 802 above the bottom teeth (assuming cutter head 802 has a similar embodiment to other embodiments of cutter heads shown in this disclosure), sensing signal 812 may be monitored while control signal 816 is controlled to drive the cutter knives of cutter head 802 to a desired position. If it is desired that the cutter knives be slightly off of center above the bottom teeth or to other beneficial positions, this may also be achieved by monitoring sensing signal 812 as control signal 816 is used to control actuator driver 818. In some embodiments cutter head 802 is vibrated in some modes of operation, so control signal 816 may be modulated at times while sensing signal 812 is monitored to control the level and frequency of vibration to a substantially desired level.

If cutter head 802 is capable of applying friction to hair without cutting it (as was shown in the embodiment of FIG. 4, for example), then control system 800 may command control signal 816 to apply substantially consistent force in the appropriate direction to cutter head 802 through actuator 806. Vibration may also be applied in such a mode of operation. As hair is extended through cutter head 802 and friction is applied as described, sensing signal 812 may be monitored to ensure that the cutter knives 802 are appropriately positioned. The amount of hair in cutter head 802 may be assessed to at least some degree, by the position of the cutter knives relative to comb teeth as measured through observation of sensing signal 812 as friction is applied to hair. That is, if cutter head 802 contains a large amount of hair, moderate pressure applied to apply friction to the hair will cause the cutter knives to move less than they would if substantially less hair were present. Assessment of the amount of hair in the cutter head 802 may be helpful to optimize control of cutting action that may follow. For example, if only a small amount of hair is detected in cutter head 802, less force may be applied in the cutting stroke of cutter head 802 to reduced power, noise, and mechanical impact. On the other hand, if assessment of sensing signal 812 under substantially constant force through cutter head 802 indicates the cutter head 802 contains a very large amount of hair, a very large actuation signal may be applied through control signal 816 so that a strong and powerful cutting stroke results to ensure that the hair in cutter head 802 is fully cut.

Control system 800 may also provide beneficial operation in the event that cutter head 802 is substantially heavily filled with thick hair and actuator 806 is not capable of cutting it on a single actuation of cutter head 802. That is, by monitoring sensing signal 812, control system 800 may determine that cutter head 802 failed to fully actuate when control signal 816 commanded actuator 806 (through actuator driver 818) to actuate cutter head 802 to cut hair. For such a condition, control system 800 may command actuator 806 to actuate in the opposite direction to rapidly apply friction to hair and then rebound from the condition of maximum applied friction to again initiate actuation to cut hair. Alternatively, if cutter head 802 is designed to cut hair when actuated in either direction, reciprocating motion of cutter head 802 may be initiated by control system 800 to drive cutter head 802 to completely cut the hair it contains through repeated actuation in a reciprocating manner. Analysis of sensing signal 812 in the course of such a control scheme used to drive cutter head 802 to cut hair through successive actuations allows control system 800 to optimize timing of application of actuation forces from actuator 806 to maximize force on cutter head 802 and take benefit of the motion of cutter head 802 (for example, taking benefit of rebounds from prior actuations). Control system 800 may also include a time out function that stops actuation of cutter head 802 if after a sufficient number of successive actuations it is deemed that additional actuations could cause overheating, failure, safety issues, or other conditions that would make stopping actuation beneficial.

Some embodiments of cutter heads 802 may be damaged if they are actuated too strongly. For example, if a top cutter is accelerated too rapidly, damage may occur when it strikes a crash stop, mounting standoff, or other feature limiting its motion. Hence, control circuit 814 may provide benefit for such embodiments in controlling actuator driver 818 so that maximum forces, maximum speed, and other possible limitations of a cutter head 802 are not exceeded in the course of operation.

Assessment of sensing signal 812 while hair has friction applied to it may allow some embodiments to measure hair length. Once a hair cutting device 200 containing a cutter head such as cutter head 802 has collected and is extending hair, sensing signal 812 may be monitored while substantially constant force is applied to hair. Per the explanation above, the amount of hair in the cutter head 802 may be assessed by the degree to which the knives of cutter head 802 have moved under the substantially constant force application. As hair is further extended, it will at some point slip out of the cutter head 802. When this occurs, sensing signal 812 may indicate a substantially sudden motion of the cutter knives of cutter head 802. Through monitoring the time at which the sudden cutter knife motion occurs, control system 800 may signal to automated hair cutting system 100 to note the location of cutter head 802, and so, determine the length of the previously extended hair. If automated hair cutting system 100 has knowledge of the style of hair of the individual whose hair is measured in this fashion, a further compensation may be made to determine the specific length of the last hair to slip out of cutter head 802 as it is extended. That is, since hair cutting device 200 may be turned or moved in various directions as hair is extended, all the hair collected in cutter head 802 may not slip from cutter head 802 at the same time. But if automated hair cutting system 100 has knowledge of the hair style of the individual being measured (for example if it was used to previously cut the individual's hair), then the loss of accuracy due to different hair slipping out of a cutter head at different times may be compensated as automated hair cutting system 100 may monitor the position and/or orientation of hair cutting device 200 at all times including when hair is collected into cutter head 802, extending through cutter head 802, and when it slips free of cutter head 802, so that automated hair cutting system 100 may determine which hair that was collected in cutter head 802 should most likely have slipped last out of cutter head 802.

Some embodiments of automated hair cutting systems may benefit from control systems 800 for controlling cutter heads 802 that allow cutter heads 802 to only cut a portion of the hair they may have collected at a given point in time. Those skilled in the art will recognize that some hair styling techniques involve layering, feathering, thinning or similar operations that involved cutting some portion of a region of hair partially so that some of the hairs in a given region of a user's 102 head are cut to different lengths. For such operations, control system 800 may partially actuate cutter head 802 so that some, but not all of the hair collected in cutter head 802 is cut. Subsequently, control system 800 may later again actuate cutter head 802, possibly after cutter head 802 has been further lifted away from user's 102 scalp to further extend hair, so that additional hair is cut. Multiple cycles of actuation of cutter head 802 may be undertaken as hair is extended to create layering, tapering, feathering, or other possibly desirable features in hair.

Control system 800 may also operate to facilitate improved operation of cutter head 802 in additional ways. For example, once hair in cutter head 802 is cut, it may be beneficial if cutter head 802 remains stationary for a short period of time so that nearby hair is not snagged or pinched. Clearly, since hair cutting device 200 may be in motion when cutter head 802 is actuated to cut hair, if nearby hair is snagged or pinched, it could be pulled out or cause pain to a user 102 using automated hair cutting system 100. Hence, it may be beneficial if braking action is applied to cutter head 802 immediately after cutter head 802 is actuated for cutting. Various possible actuators 806 may provide braking action. For example, voice coil actuators normally allow braking to be provided simply by shorting the wires of the voice coil. Alternatively, sensing signal 812 may be monitored and control signal 816 controlled to keep cutter head 802 stationary whether or not actual braking is applied.

Operation of automated hair cutting system 100 involves operation of a hair cutting device 200 that includes a cutter head such as cutter head 802 near the ears, eyes, and face of a user 102. Hence, operation of cutter head 802 in a safe manner is important. Normally, only hair should be present in cutter head 802. However, it may be possible for cutter head 802 to snag the ear or other facial feature of a user 102. Control system 800 may be configured to beneficially detect that something other than hair is collected in cutter head 802, at which time cutting operation of cutter head 802 may be suspended and user 102 may be notified of the condition through electronic computing device 106 or through some other signal. Applying force to cutter head 802 in a direction to apply friction to hair and sensing for an appropriate level of motion of the cutter knives of cutter head 802 through observation of sensing signal 812 may be used to detect if cutter head 802 is jammed and may be obstructed with something besides hair. Detection that something other than hair is in cutter head 802 may not be completely precise as hair may put pressure on the cutter knives of cutter head 802 in many different ways depending on the nature of the hair of user 102 and the manner in which it is collected and extended. However, it is noted that if it is falsely signaled that something other than hair is in cutter head 802, and cutting operation is falsely suspended, that no harm comes to user 102 and user 102 need only try again to collect, extend, and cut the region of hair (such as region of hair 104 in FIG. 1) that was previously not cut. Hence, falsely indicating a cutter head 802 may contain something besides hair may not be a significant problem (unless it occurs so often as to be annoying).

Detection of something other than hair in cutter head 802 may benefit from knowledge by control system 800 of the region in which cutter head 802 is located, the nature of the hair of user 102, and other factors. For example, if repeated collection, extension, and cutting of regions of hair indicate a user 102 has rather thin and light hair (as evidenced by monitoring the amount of hair in cutter head 802 through the course of operation), control system 800 may adapt so that it provides an indication of something other than hair in cutter head 802 if it detects a significant increase in the amount of hair (or something else) in cutter head 802 at some point. That is, thresholds for the level at which a cutter head 802 is considered to have something other than hair in it may be adapted to a specific user. Automated hair cutting system 100 may also have additional information that can help control system 800 make distinctions about whether cutter head 802 contains something besides hair. For example, if automated hair cutting system 100 is aware that a young child is using automated hair cutting system 100 to cut their own hair, then automated hair cutting system 100 may enter a mode in which it is especially careful and signals an obstructed cutter head 802 even if minimal evidence shows an obstruction may be present. Adult and professional operators of automated hair cutting system 100 may be warned and/or cautioned to be careful, but settings for signaling obstructions may be relaxed somewhat versus those when a child operates automated hair cutting system 100. It is also possible to adjust trigger levels for when obstructions are signaled based on the location of hair cutting device 200 and cutter head 802. For example, if automated hair cutting system 100 determines that cutter head 802 is very close to the ears or eyes of user 102, then it may send warnings to user 102 through electronic computing device 106 to be careful and may also use more sensitive settings for detection of obstructions in cutter head 802. Other information such as the skill level of the operator of automated hair cutting system 100, the age of user 102, the type of hair (i.e. thick or thin, etc.) of user 102, and other possible factors may be used in determining appropriate sensitivity levels for the detection of obstructions in cutter head 802.

As noted above, some embodiments of automated hair cutting system 100 may apply momentary friction to hair as it is being extended to test for the presence of obstructions other than hair in cutter head 802. That is, even if no pressure or friction is needed for beneficial manipulation of hair, cutter head 802 may be actuated to momentarily apply friction so that obstructions may be detected. In some cases, this may result in a user 102 being pinched, for example, if they have inadvertently caught their ear in cutter head 802. Mild pain from a pinched ear may be generally preferred to a system that cuts hair without such monitoring and may also cut a user's 102 ear. This concept may be extended to provide signals to a user 102. Application of force or vibration to cutter head 802 during extension of hair may allow a user to feel a suitable sensation in the course of a haircut. Mild vibration, for example, of cutter head 802 may normally indicate to user 102 that all is operating normally. However, if control circuit 814 senses that something may be caught in cutter head 802, higher levels of vibration, higher levels of force, a special pattern of vibration (such as vibration pulsing on and off, vibration cycling through various amplitude levels, etc.), haptic signals, warning buzzers, or other signals may be used to indicate to a user 102 that something may be caught in cutter head 802. And as noted above, if the thing caught in cutter head 802 is part of a user's 802 body, they may notice some additional sensations, possibly including pain, as well.

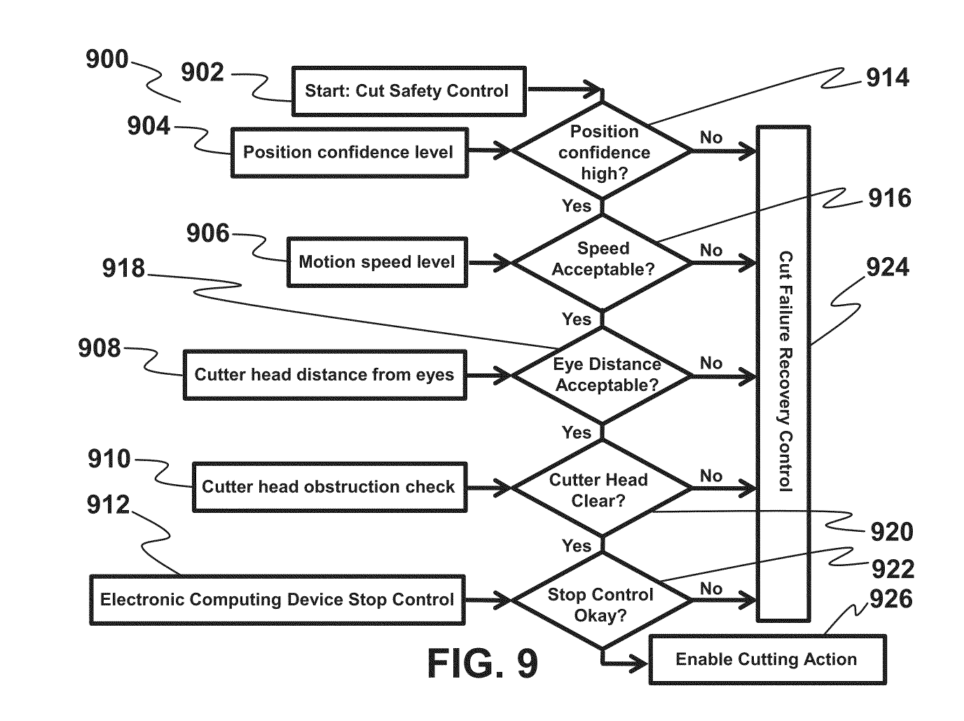

FIG. 9 illustrates one embodiment of cut safety control 900 which may be used in cutting hair according to the present disclosure. The decision criteria and other concepts presented in FIG. 9 may be implemented using digital logic circuitry in electronic hardware to provide an electronic digital indication of whether or not hair may be cut, using analog circuit analysis of sensor signals and derived signals to provide an analog electronic indication of whether or not hair may be cut, using software algorithms on programmable digital hardware to provide electronic indications in software of whether or not hair may be cut, using combinations of techniques, or using other suitable techniques.

Cut safety control 900 ensures that actuation of a cutter head in an automated hair cutting system 100 is only commanded when appropriate conditions are met such that the cutter head may be actuated substantially safely and substantially without causing injury. Cut safety control 900 may be implemented as part of control system 800 or may be implemented in other elements of automated hair cutting system 100, which may provide signals to control system 800 to help ensure that hair cutting is achieved as safely as possible. Cut safety control 900 begins with a start box 902. Decision box 914 verifies the positioning and/or orientation for the location of a hair cutting device 200 relative to the head of a user has high confidence. The high confidence decision is made after receiving position confidence feedback 904. Position confidence is determined based on many factors, including signal strength, signal strength consistency over the last several position estimates, variance of position errors when reference points are re-checked, difference between extrapolated position estimates from prior position and velocity information versus sensor readings, correlation level of CDMA (code division multiple access) codes or other codes contained in signals used, and other factors. If the confidence in the position confidence level is high, feedback will be given to confidence decision box 914 and the decision process continues with speed acceptability decision box 916. If confidence in the position estimate is not high, position confidence decision box 914 will direct the cut safety control 900 to a cut failure recovery control 924.

Speed acceptability decision box 916 receives input from motion speed level box 906 and verifies speed settings of hair cutting device 200, including determining if hair cutting device 200 is moving too quickly for safe and effective hair cutting to take place. Speed of hair cutting device 200 may be estimated by automated hair cutting system 100 and it is important that hair cutting device 200 not be moving so fast that hair might pinch or pull out instead of being cut if cutting action is to occur. Additionally, if hair cutting device 200 is moving too fast, it may have been dropped, user 102 may have stumbled or fallen, or other things may have occurred that would make cutting hair undesirable. Speed acceptability may also be a function of the position of a hair cutting device 200 as an automated hair cutting system 100 may insist that slower speeds of motion be used around a user's eyes and ears versus areas where injury is substantially less likely to occur. If speed acceptability decision box 916 determines that speed is acceptable it directs cut safety control 900 on to eye distance acceptability decision box 918. If speed acceptability decision box 916 determines that speed is not acceptable, it directs cut safety control 900 to cut failure recovery control 924.

Eye distance acceptability decision box 918 receives information from cutter head eye distance box 908 and verifies the cutting head is at a safe distance from a user's eyes. Distance from a user's 102 eyes is very important as most injuries that are possible with an automated hair cutting system 100 are of a minor nature. In the unlikely event that automated hair cutting system 100 inadvertently cuts a user 102, the design of the cutter heads may be such that the injury would most likely be only a minor cut. However, if the cutter head of hair cutting device 200 were to be positioned too close to the eyes of user 102, then more serious injuries may occur. In normal operation of automated hair cutting system 100, hair may be extended above, in front of, or to the sides of the head of user 102 such that the cutter heads are not close to the user's eyes or face. However, a safety feature may be utilized such that cutting action is disabled when a cutter head is judged to be too close to the eyes of a user 102. The distance from which the cutter head of a hair cutting device 200 should be from a user's 102 eyes for safe cutting action will vary with different possible embodiments of automated hair cutting system 100, but for some embodiments, a safe distance from a user's eyes may be at least ½ inch. Accordingly, if eye distance acceptability decision box 918 determines that the distance from the cutter head to a user's 102 eyes is acceptable it will direct cut safety control 900 to cutter head obstruction decision box 920. If eye distance acceptability decision box 918 determines that the distance from the cutter head to a user's 102 eyes is not acceptable, it will direct cut safety control 900 to cut failure recovery control 924.

Cutter head obstruction decision box 920 takes input from cutter head obstruction check box 910 and verifies that the cutter head is free of obstructions. As noted above, cutter head obstruction may be checked through actuation of a cutter head to determine if the position of cutter knives is consistent with the presence of hair for the level of force applied. If cutter head obstruction decision box 920 determines that the cutter head is not improperly obstructed, it directs cut safety control 900 to stop control decision box 922. If cutter head obstruction decision box 920 determines that the cutter head is obstructed, it directs cut safety control 900 to cut failure recovery control 924.

Stop control decision box 922 checks inputs from electronic computing device stop control box 912 to verify that the cutter head is configured to respond to a stop command, including determining if user 102 or another person is directing automated hair cutting system 100 through controls available on electronic computing device 106 to stop cutting action. In operation of automated hair cutting system 100, electronic computing device 106 may provide information and directions to user 102 or to other persons. In addition, electronic computing device 106 may include touch screen buttons or other controls to allow user 102 or other persons to stop cutting action. In some embodiments, a large brightly colored area of the screen of electronic computing device 106 may be used as an emergency stop so that all cutting action stops if it is touched. There may also be other ways for a user 102 or other persons to stop cutting action. Voice commands, motion of hair cutting device 200 (moving hair cutting device 200 toward the scalp of user 102, for example, may be used to signal that cutting action should be stopped), button 214 (in FIG. 2), combinations of stop commands, or other possible stop commands are possible. Touch sensor 205 shown in FIG. 2 may also be used for a stop command as a user 102 may simply push the cutter head of hair cutting device 200 up against their head to actuate touch sensor 205 as a signal to automated hair cutting system 100 that they want cutting action to cease. Stop control decision box 922 may check all available stop commands for a given embodiment of automated hair cutting system 100 and only allow cutting action if all are clear. If stop control decision box 922 determines that no stop commands are present, it directs cut safety control 900 to enable cutting action box 926. If stop control decision box 922 determines that a stop command has been delivered, it directs cut safety control 900 to cut failure recovery control 924.

Enable cutting action box 926 may enable cutting action of the cutter head of a hair cutting device 200 so that hair may be cut. Cut safety control 900 may be run multiple times before hair is actually cut or may even be run continuously in the course of operation of an automated hair cutting system 100 so that automated hair cutting system 100 has substantially continuous information regarding whether or not it is safe to cut hair. Running cut safety control 900 sufficiently regularly so that cut safety information is available substantially continuously would allow automated hair cutting system 100 to provide direction to user 102 to use automated hair cutting system 100 in a substantially safe way. For example, if cutter head of hair cutting device 200 is too close to the eyes of user 102, automated hair cutting system 100 could direct user 102 to extend their hair away from their eyes so that cutting is not disabled and hair may be safely cut.

Cut failure recovery control 924 may contain controls or direct automated hair cutting system 100 to controls that provide information to user 102 that hair cutting is not enabled and the reasons why. For example, cut failure recovery control 924 may direct automated hair cutting system 100 to display on electronic computing device 106 that hair cutting device 200 is being moved too rapidly for safe hair cutting. In this way, user 102 may correct their use of automated hair cutting system 100 so that safe and effective hair cutting may resume. Of course, once cut failure recovery control 924 is entered, cutting action of the cutter head of hair cutting device 200 may be disabled and, for some embodiments, may only be enabled again if cut safety routine is acceptably passed on a subsequent attempt. Since operation of automated hair cutting system 100 is such that if cutting action is disabled when hair is extended for cutting there is no harm and only minor inconvenience to a user 102, embodiments of cut safety controls 900 may be designed to disable cutting action any time there is evidence that cutting hair may not be safe.

Cut failure recovery control 924 may also provide special modes to assist user 102 if certain situations arise. For example, if automated hair cutting system 100 determines that a cutter head is jammed, user 102 may be given options to allow them to more easily extract (and possibly untangle) a cutter head from their hair. For such a situation, user 102 may be offered an operating mode in which a cutter head is slow actuated back and forth at low force levels so that the motion of the cutter head allows hair that may be snagged, jammed, or tangled to be slowly released. Other failure recovery modes are possible for various embodiments of automated hair cutting systems 100.

Additional factors for hair cutting safety may be incorporated into embodiments of cut safety control 900 in addition to those shown in the embodiment of FIG. 9. Position estimate confidence level, velocity estimate confidence level, motion speed level, cutter head distance to eyes, cutter head obstruction, electronic computing device stop control, safety button 214, voice commands, cutter head distance to ears, combinations of stop commands, or other possible safety elements may be included. It is also possible to vary acceptable safety levels depending on the position of the cutter head of hair cutting device 200. For example, it may be fine to cut hair when hair cutting device 200 is moving rather rapidly above the head of user 102 and extending hair above and away from user's 102 head. Since hair cutting device 200 is in a generally safe area, more rapid speed could be allowed for hair cutting in such a manner. However, if the cutter head of hair cutting device 200 is close to the ears of user 102, cut safety control 900 may incorporate a speed control such that the allowed speed of motion of hair cutting device 200 may be reduced substantially to avoid any accidental contact or injury with the ear(s).

Many other safety-related controls, safety information messages, safety information, and other elements of a safe automated hair cutting system 100 are possible. For example, when an automated hair cutting system 100 is first powered on and before hair is collected in a cutter head, a control system 800 may cycle cutter head 802 through its range of motion while monitoring sensing signal 812 to ensure that reasonable levels of force produce reasonable levels of motion and acceleration. Failure of a cutter head 802 to respond to applied force when no hair is present may indicate that cutter head 802 has been damaged and may not be safe for use, that cutter head position sensors are not working properly, or that other problems exist. Hence, additional safety routines in the spirit of cut safety control 900 may be applied in an automated hair cutting system 100.

Disclosed hereinabove are embodiments of sensing and control features for use with automated hair cutting systems which enable hair to be manipulated and cut. Cut stroke decision criteria may be established to help ensure that a cutter head is only actuated to cut when high confidence exists that it is being done correctly and safely. Fail-safe intercommunication and synchronization between system elements may allow electronic computing devices, hair cutting devices, positioning devices, and possibly additional system elements to reliably and safely exchange system and control information and to interoperate successfully in an automated hair cutting system. Sensing of cutter head position using optical, magnetic, ultrasonic, or other sensing techniques may allow cutter heads to be substantially precisely controlled, may allow the amount of hair in a cutter head to be sensed prior to a cutting stroke, may allow the presence of things in cutter heads that are not hair to be sensed, and may allow incorrect operation or damage of a cutter head or a cutter head sensor to be detected. Precision tolerances and manufacturing of cutter heads may include one or more positions at which sensors may be calibrated to avoid the need for precise placement of sensors.

Those skilled in the art to which this application relates will appreciate that other and further additions, deletions, substitutions and modifications may be made to the described embodiments.

1. An automated hair cutting system, comprising:
a hair cutting device;
at least one sensor, said sensor providing signals utilized by said automated hair cutting system to compute a position of said hair cutting device relative to a user's head and face; and
a control system for actuating a cutter head attached to said hair cutting device, said cutter head configured for collecting hair therein during operation of said hair cutting device and thereafter cutting the collected hair according to the user's selected hair length and hair style;
wherein the control system executes a safety sequence for initiating the hair cutting device comprising multiple pre-defined safety verifications before beginning operation of the hair cutting device.

2. The automated hair cutting system of claim 1, wherein at least one of a positioning device or an electronic computing device are interconnected to said hair cutting device through an electronic interface.

3. The automated hair cutting system of claim 2, wherein said electronic interface conveys electronic signals according to a protocol in which said control system is prohibited from actuating said cutter head at least for hair cutting operations if said electronic interface fails to convey at least one electronic signal between said hair cutting device and said at least one of a positioning device or an electronic computing device.

4. The automated hair cutting system of claim 2, wherein electronic interface conveys electronic signals that include an indication of time so that upon receiving said electronic signals that include an indication of time, said hair cutting device and said at least one of a positioning device or an electronic computing device operate to substantially synchronize with each other in time.

5. The automated hair cutting system of claim 1, wherein said control system monitors at least one sensor configured to sense a position of at least one cutting element of said cutter head.

6. The automated hair cutting system of claim 5, wherein said control system actuates said cutter head so that said at least one cutting element of said cutter head is positioned to at least one preferred position, and utilizes the associated output of said sensor when said at least one cutting element is at said at least one preferred position, to generate a calibration for use in improvement of subsequent readings.

7. The automated hair cutting system of claim 1, wherein said control system actuates said cutter head to cut only a portion of the hair collected in said cutter head on each of a plurality of subsequent actuations.

8. The automated hair cutting system of claim 5, wherein said control system monitors said at least one sensor while actuating said cutter head to compress and apply friction to hair collected in said cutter head, and generates an estimate of the quantity of hair collected in said cutter head from analysis of an output of said sensor.

9. The automated hair cutting system of claim 1, wherein said pre-defined safety verifications comprises at least a position of said hair cutting device determined to be at or above a pre-defined confidence level.

10. The automated hair cutting system of claim 1, wherein said pre-defined safety verifications comprises a criteria that the motion speed of said hair cutting device is estimated to be below a pre-defined acceptable motion speed level.

11. The automated hair cutting system of claim 1, wherein said pre-defined safety verifications comprises a criteria that the distance between said cutter head and the nearest eye of a user operating said cutting device is estimated to be above a pre-defined acceptable distance.

12. The automated hair cutting system of claim 1, wherein said pre-defined safety verifications comprises a criteria that a user operating said system has not signaled to said automated hair cutting system that hair cutting operations must cease.

13. A control apparatus for use with automated hair cutting systems, comprising:
at least one sensor configured to determine a position of a cutting device relative to a user's head;
a communication link for communicating with the cutting device; and
a computing device for processing information from the at least one sensor and preparing instructions for the cutting device.

14. The control apparatus according to claim 13, wherein the computing device sends additional instructions to the cutting device, said additional instructions include a stop cutting instruction.

15. A method for initiating a hair cutting system comprising a cutter head, control device, and a plurality of sensors, the method comprising:
verifying positioning of the cutter head relative to the user's head;
verifying, based on input from at least one of the plurality of sensors, that the cutter head is positioned at a minimum distance away from the user's eyes;
verifying that the cutter head is free of obstructions;
verifying that the cutter head is configured to respond to a stop command from the control device; and
initiating the hair cutting system.

16. The method according to claim 15, further comprising after initiating the hair cutting system, monitoring the cutter head for hair load and hair collected within the cutter head.

17. The method according to claim 15, further comprising after initiating the hair cutting system, monitoring motion speed of the cutter head relative to position of the cutter head relative to the user's head as determined by the plurality of sensors.

18. The method according to claim 15, wherein the cutter head comprises at least one sensor.

19. The automated hair cutting system according to claim 18, wherein the at least one sensor is configured to detect at least one condition requiring stopping cutting action, said condition selected from the group consisting of a blockage in the cutter head, the cutter head has collected a maximum amount of hair, and a misalignment of cutting head components has occurred.

20. The method according to claim 15, further comprising after initiating the hair cutting system, monitoring the cutter head for hair load and hair collected within the cutter head as the cutter head is extended from the scalp of a user and detecting when said hair load substantially changes to provide an indication of the length of the collected hair.
